(19) United States
(12) Patent Application Publication
(10) Pub. No.: US 2025/0335707 A1
(43) Pub. Date: Oct. 30, 2025

(54) DOMAIN-KNOWLEDGE GUIDED AGENT FRAMEWORK FOR AUTOMATED SYSTEM ANALYSIS

(71) Applicant: PAYPAL, INC., San Jose, CA (US)

(72) Inventors: Juan Xu, Shanghai (CN); Jia Shi, Shanghai (CN); Sheng Liu, Shanghai (CN); Lin Zhu, Shanghai (CN); Rao Fu, Shanghai (CN)

(21) Appl. No.: 18/647,504

(22) Filed: Apr. 26, 2024

(51) Int. Cl. G06F 40/20; G06F 21/62

(52) U.S. Cl. CPC G06F 40/20; G06F 21/62

(57) ABSTRACT

There are provided systems and methods for a domain-knowledge guided agent framework for automated system analysis. An online transaction processor or other service provider may provide computing services and platforms to entities, which may require compliance enforcement for different policies, regulations, and the like. To provide compliance review, investigations, and enforcement in a computing system of a service provider, the service provider may implement an intelligent and automated agent and framework that may utilize different large language models for processing compliance investigation requests and queries. The agent may utilize the models to plan and execute tasks using an available toolkit of computing operations and capabilities for compliance investigation. A data guard module may also be used to ensure data privacy and security is maintained. Within a main task, sub-tasks may be executed by models with specific domain knowledge.

### TECHNICAL FIELD

The present disclosure relates generally to artificial intelligence (AI) and machine learning (ML) systems and models, and more specifically to automating compliance investigations through a digital agent or bot and computing framework that implements multiple large language models (LLMs).

### BACKGROUND

In compliance case review, investigators analyze information to determine the disposition and/or whether a suspicious activity report (SAR) should be filed, or a referral created. While handling numerous cases, it is time-consuming and challenging for human agents to handle the investigation or other analytical tasks manually. As the volume of cases increases, the existing array of tools available to human agents may lack cohesive integration, hindering the optimal utilization of collective knowledge within the organization. For instance, investigators frequently use distinct tools to analyze various data including transaction knowledge graphs, transaction memos/dispute memos, account linking knowledge graphs, external searches, etc. This segmented process not only results in considerable time due to the necessity of alternating between various tools, but also requires a substantial analytical effort from investigators to meticulously piece together and interpret the collected information from multiple sources for conclusive and accurate decision making.

A solution to these technical problems in fraud investigations is required to address limitations with conventional fraud detection systems while streamlining investigative workflows, providing accurate and timely insights, and maintaining data security. Thus, it is desirable to automate labor-intensive processes, reduce investigator time, and enhance financial crime detection and investigation efficiency. Therefore, there is a need for an automated, intelligent, and efficient computing system and framework that can assist and augment investigator capabilities, automate repetitive tasks, and provide actionable insights while enhancing efficiency and accuracy, while reducing operational costs and computing resource usage.

### BRIEF DESCRIPTION OF THE DRAWINGS

FIG. 1 is a block diagram of a networked system suitable for implementing the processes described herein, according to an embodiment;

FIG. 2 is an exemplary system environment where an intelligent and automated agent may be provided through a framework that provides compliance investigations through large language models and other components, according to an embodiment;

FIGS. 3A and 3B are exemplary diagrams of prompts and responses from large language models that may be implemented with an automated agent for a compliance investigation framework, according to various embodiments;

FIG. 4 is a flowchart of an exemplary process for a domain-knowledge guided agent framework for automated system analysis, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for a domain-knowledge guided agent framework for automated system analysis. Systems suitable for practicing methods of the present disclosure are also provided.

A service provider, such as an online transaction processor, may provide computing services to users and/or their corresponding entities, which may include end users and customers, merchant customers of an online transaction processor, businesses and their representatives and/or employees, and the like. In some embodiments, these computing services may include those associated with electronic transaction processing, payments, and/or cryptocurrency trading and payment processing. Such computing services may have corresponding laws, rules, and regulations that require compliance review, enforcement, and investigations for adherence.

For example, data privacy, security, retention, and/or remediation when leaks, hacks, or exploitation occurs is often regulated and/or has laws governing actions with data and computing services that service provides may take. As such, compliance teams and enforcement mechanisms at a service provider may be utilized to enforce data usage and computing services that are restricted or allowable, uses of data, storage retention and security, and the like. When investigating potential compliance issues or breaches, as well as investigating different policies, systems, applications, websites, and the like for adherence to compliance requirements, a service provider may implement an autonomous agent and compliance investigation framework. For example, when investigating compliance with a specified policy for accounts, the potential risk and loss associated with certain accounts are evaluated and an investigator may initially use a business intelligence (BI) tool to identify the accounts according to specified criteria. Subsequently, a risk-based assessment approach may be employed. This involves scrutinizing profiles, analyzing transaction patterns, examining account linkages, and the like. Throughout this process, the investigator may rely on both internal and external tools to gain insights into the intent and business of the account holders and their activities. As such, a service provider may utilize LLMs with an automated agent and framework for compliance investigations with the different data, services, applications, websites, and the like of a service provider.

In order for users to utilize computing services of the service provider, the service provider (e.g., an online transaction processor, such as PAYPAL®) may require users and other entities requesting the services to have an account with the service provider. A user wishing to establish an account may first access the online service provider and request establishment of the account. When establishing accounts, login and/or corresponding authentication information with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The user may also be required to provide financial information, including payment card (e.g., credit/debit card) information, bank account information, gift card information, benefits/incentives, and/or financial investments. The user may also establish, purchase, trade, and/or store cryptocurrency (e.g., through storage, exchange, and/or use of private keys for cryptocurrency values, tokens, or digital currency).

This information may be used to process transactions for items and/or services and provide assistance to users with these payment instruments and/or payment processing. In some embodiments, the account creation may establish account funds and/or values, such as by transferring money into the account and/or establishing a credit limit and corresponding credit value that is available to the account and/or card. Funds may also be established by storing private keys and/or generating, maintaining, and/or linking the account to an online digital “hot” wallet and/or offline digital “cold” wallet for cryptocurrency. The online payment provider may provide digital wallet services, which may offer financial services to send, store, and receive money, process financial instruments, and/or provide transaction histories, including tokenization of digital wallet data for transaction processing. The application or website of the service provider, such as PAYPAL® or other online payment provider, may provide payments and other transaction processing services.

Once the account of a user is established with the service provider, the user may utilize the account via one or more computing devices, such as a personal computer, tablet computer, mobile smart phone, or the like. The user may engage in one or more online or virtual interactions that may be associated with electronic transaction processing, images, music, media content and/or streaming, video games, documents, social networking, media data sharing, microblogging, and the like. Similarly, the merchants may use the accounts when providing their merchant services to customers, such as during electronic transaction processing. Different online use of accounts and/or computing services of the service provider may therefore require compliance enforcement with laws, rules, and regulations, which may be provided by the service provider using the intelligent and autonomous agent and framework discussed herein.

In this regard, a service provider may provide an autonomous analysis agent to address these challenges and enhance the efficiency of various analysis tasks during compliance investigation and other compliance, fraud, or risk related tasks and operations. This may be done through an automated agent and computing framework that may provide intelligent analysis through AI systems, such as those that may implement LLMs for generative and conversational AI bots. As such, the framework may be generalized as well as customizable for different purposes and focuses using different trainable and configurable LLMs, for example, for tasks associated with customer due diligence, risk assessment, compliance investigation, and the like. Using this intelligent solution through LLMs and automated agent bots or processes, the service provider may automate and provide a more efficient, faster, and more accurate financial crime and compliance violation investigation system.

The service provider may implement the compliance investigation framework with different LLMs, including a more generalized LLM that may provide initial planning, reasoning, and conversational skills for a conversational AI bot, and a more specialized LLM that may provide specific domain knowledge of particular areas of compliance, domains or services of the service provider, jurisdictions, and the like. As such, the framework may leverage LLMs' capabilities for planning and reasoning, which may allow automated agents (e.g., programs, applications, computing bots, or the like) to integrate with the existing tools for extracting specific insights from raw data for users and the service provider. As such, an automated agent may reply to compliance and fraud investigation questions, queries, tasks, or instructions. This agent may be guided by institutional knowledge along the process of responding to prompts for investigations in order to complete the investigation task, which may consider the privacy of proprietary and/or available data. The framework may introduce an improved and automated analysis system for compliance investigation that efficiently processes analytical tasks automatically. This system may therefore improve the scalability and speed of various analysis, addressing the challenges associated with handling large volumes of investigative data.

To provide the automated agent and computing framework, the service provider may build a domain-knowledge guided framework for an automated agent. This may include an LLM augmented with a knowledge agent as an automated bot or application that may respond to users and integrate with the LLM, toolkits, and other available components of the framework for compliance investigations. The knowledge agent may serve as a centralized hub, thereby aggregating and synthesizing various information from the service provider's compliance policy, as well as any third-party, external, or other entity's compliance policy, rules, or regulations. The knowledge agent may be provided access to knowledge that may be dispersed among personnel involved in the investigative process. By doing so, the framework may bridge the gap between the general knowledge encapsulated by LLMs and the specific domain requirements for an investigative or analytical context of compliance investigations. This integration ensures a more nuanced and context-aware analysis, improving the system's adaptability to the intricacies of the specific domain and/or knowledge required for compliance investigations.

The service provider may implement a dual LLM worker mechanism with the framework and agent, which may utilize collaborative memory sharing between the LLMs of the dual LLM worker mechanism. The dual LLM worker mechanism with collaborative memory may include a main and specialized worker. The main-LLM-worker may assume responsibility for overall reasoning and planning to address the overall or overarching task of the compliance investigation, while the specialized-LLM-worker may focuses on specific subtasks needed to complete the overall task, such as steps in an investigation (e.g., data collection, data summarization, analytics, suspicious activity report (SAR) generation, etc.). To enhance the comprehensive and global perspective of the specialized-LLM-worker, the collaborative memory mechanism may be used to share data from the overall task and different components with the specific task being performed by the specialized-LLM-worker. This mechanism leverages the strengths of both main-LLM-worker and specialized-LLM-worker to contribute to a more cohesive and informed decision-making process during analysis and investigation by each LLM and worker operations utilizing the LLMs.

In this regard, a conversational AI engine and system may include one or more LLMs, as well as other machine learning (ML) models, neural networks (NNs), or the like, to converse with users during compliance investigations. These may include LLMs and/or generative AIs for chatbots, such as generative pretrained transformers (GPTs) including ChatGPT™. Training of the LLM or other AI for the automated agent may be performed using data for the service provider and/or compliance requirements, rules, regulations, past investigations or other information of the service provider that may be utilized with and/or generated from computing services and data monitored for compliance. During training of a conversational AI model, the model may be trained to make predictions and recommendations, as well as other guidance, planning and executing tasks during compliance investigations. In this regard, the conversational AI of the agent may include and/or be connected with one or more LLMs and/or GPTs, which may provide generative AI services and interactions for an automated chat assistance during compliance investigations.

Further, the framework may protect secure and/or private data from being exposed and/or revealed during compliance investigations to unauthorized parties using a data-guard insight module. To address data privacy concerns, the framework may incorporate data processing techniques to hide data when responding to prompts for compliance investigations, such as masking sensitive information, transforming raw data into insights, and the like. As such, the framework, in one embodiment, may include five main parts, a main-LLM-worker module, a knowledge agent module, a memory module, a toolkit module (including a specialized-LLM-worker), and a data-guard module, although other configurations may also be used. The purpose of the main-LLM-worker module may be to identify the role of the automated agent in the compliance investigation, identify and understand the overall task for the investigation, access and utilize the tools available for use, and perform planning and reasoning to complete the overall task.

With these actions, other modules may be invoked to process the overall task and provide a response to one or more prompts for the compliance investigation. The memory module jointly with the main-LLM-worker may place an instance of the automated agent into a dynamic computing environment, enabling the agent to recall past behaviors and plan future actions. The toolkit module may be responsible for translating the agent's plans and executing actions for specific outputs using available resources, applications, and the like. This may include invoking the specialized-LLM-worker to perform sub-tasks requiring domain-specific knowledge and/or specialized LLM usage. The toolkit module may return the results of executing actions to the main-LLM-worker for future decisions. Along the process, the knowledge agent may feed business domain knowledge to the main-LLM-worker, which may facilitate correct planning and reasoning of the investigation task(s) aligned with business and policy rationale and/or concerns. Data prompts to the LLM and responses to such prompts may be safeguarded by the data-guard module. Within these modules, the knowledge agent may guide the main-LLM-worker, the main-LLM-worker may perform and impact the memory for planning and reasoning for the task(s), and collectively, these three modules in addition to data-guard part may utilize the toolkit module with specialized-LLM-worker module for different task execution and performance.

As such, the intelligent compliance investigation framework and system may provide a more efficient, accurate, and secure environment for compliance investigations through the provision of a digital automated agent and assistant that employs use of LLMs, conversational AIs, and other AI components. This agent may therefore enable automating the tasks required during compliance investigations while uniting data from many different resources, allowing for a broader and more encompassing investigation of data needed for compliance enforcement and adherence. As such, investigations may be completed in a more accurate manner, efficiently with less manual intervention and efforts, while safeguarding private and secure data from revelation or breach by unauthorized users and entities. This allows for coordinated communications between different system components to improve compliance investigation frameworks for computing systems and data of online service providers.

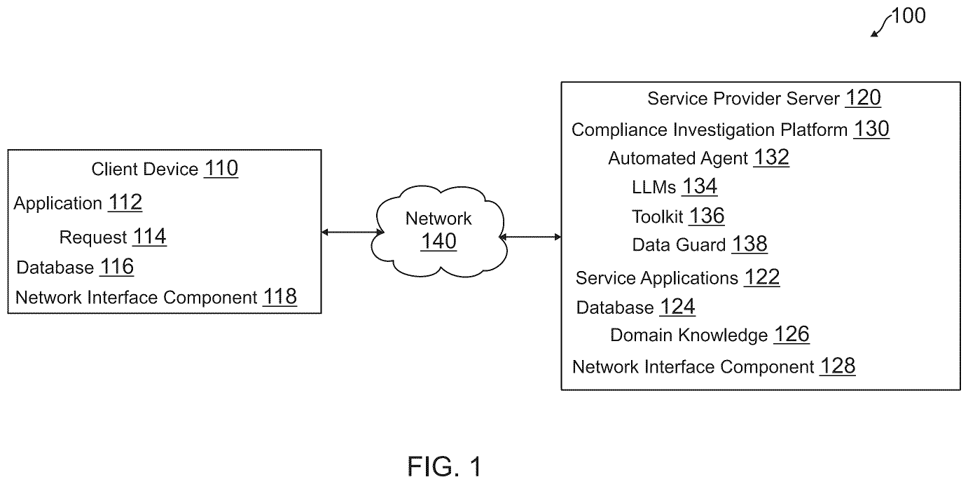

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., iOS, Android, Google OS, etc.), a merchant and/or point-of-sale (POS) device OS, or another suitable device and/or server-based OS. It can be appreciated that the devices and/or servers illustrated in FIG. 1 may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100 includes a client device 110 and a service provider server 120 in communication over a network 140. Client device 110 may be utilized by an internal agent or other internal user, such as an investigator or other agent of an entity associated with service provider server 120, to receive communications over network 140, where service provider server 120 may provide various data, operations, and other functions over network 140 to provide services to merchants, users, and computing devices. In this regard, client device 110 may be used to perform a compliance investigation, which may utilize an intelligent agent and framework that includes one or more LLMs, as discussed herein.

Client device 110 and service provider server 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be implemented as a communication device of an investigator, agent, or other internal user associated with service provider server 120. Client device 110 may utilize appropriate hardware and software configured for wired and/or wireless communication with service provider server 120. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 includes and/or is associated with an application 112, a database 116, and a network interface component 118, implementations of which are discussed further below. The application 112 may correspond to executable processes, procedures, and/or applications with associated hardware. In other embodiments, client device 110 may include additional or different modules having specialized hardware and/or software as required.

Application 112 may correspond to one or more processes to execute software modules and associated components of client device 110 to provide features, services, and other operations for a user for use with service provider server 120, such as to provide access to and service of computing services provided by service provider server 120 (e.g., for compliance investigations, review, enforcement, and other compliance adherence tasks). In this regard, application 112 may correspond to specialized software utilized by a user of client device 110 to generate and transmit a request 114 for a compliance investigation, such as a prompt, question, query, or other communication transmitted to an automated agent 132 of service provider server 120 for response using one or more of LLMs 134. In some embodiments, request 114 may specify compliance and/or investigation data including fraud indications or reports, SARs, transaction chargebacks or disputes, network traffic, firewall, and other computing logs, and the like. Application 112 may also be utilized to review and address responses to request 114, including performing compliance investigations based on the tasks, performing system, application, and/or website maintenance, debugging code, applications, websites, or the like, reviewing and/or rolling back code changes or updates, testing and troubleshooting, and the like.

Application 112 may correspond to a general browser application configured to retrieve, present, and communicate information over the Internet (e.g., utilize resources on the World Wide Web) or a private network. For example, application 112 may provide a web browser, which may send and receive information over network 140, including retrieving website information, presenting the website information to the user, and/or communicating information to the website. However, in other examples, application 112 may include a dedicated application of service provider server 120 or other entity that may interact with service provider server 120 during compliance investigations. Thus, application 112 may also correspond to different service applications and the like. When utilizing application 112 with service provider server 120, application 112 may transmit request 114 and receive responses to such prompt, question, or query for an LLM, where request 114 may be transmitted during the course of a compliance investigation.

Client device 110 includes other applications as may be desired to provide features to client device 110. For example, these other applications may include security applications for implementing client-side security features, programmatic client applications for interfacing with appropriate application programming interfaces (APIs) over network 150, or other types of applications. Other applications on client device 110 may also include email, texting, voice and IM applications that allow a user to send and receive emails, calls, texts, and other notifications through network 150. In various embodiments, the other applications may include those that may be utilized in the course of compliance investigations, system administration, maintenance, debugging, error resolution, engineering, and the like. The other applications may include device interface applications and other display modules that may receive input from the user and/or output information to the user. For example, client device 110 may contain software programs, executable by a processor, including a graphical user interface (GUI) configured to provide an interface to the user. The other applications may use devices of client device 110, such as display devices capable of displaying information to users and other output devices, including speakers.

Client device 110 may further include or have access to database 116, which may correspond to different types of data storage and components including cloud computing storage nodes, remote data stores and database systems, distributed database systems over network 140, and the like used to store various applications and data. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the user/client device 110 to service provider server 120.

Client device 110 includes at least one network interface component 118 adapted to communicate with service provider server 120 and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider server 120 may be maintained, for example, by an online service provider, which may provide computing services and operations via one or more digital platforms, applications, websites, and the like. Service provider server 120 may provide computing services to various entities, which may include computing services provider to internal and/or external users. As such, during the course of service provision, compliance review and investigations may be performed to ensure compliance with required laws, rules, and regulations (e.g., fraud investigations for transaction processors). In one example, service provider server 120 may be provided by PAYPAL®, Inc. of San Jose, CA, USA. However, in other embodiments, service provider server 120 may be maintained by or include another type of service provider.

Service provider server 120 of FIG. 1 includes and/or is associated with a compliance investigation platform 130, service applications 122, a database 124, and a network interface component 128, implementations of which are discussed further below. Compliance investigation platform 130 and service applications 122 may correspond to executable processes, procedures, and/or applications with associated hardware. In other embodiments, service provider server 120 may include additional or different modules having specialized hardware and/or software as required.

Compliance investigation platform 130 may correspond to one or more processes to execute modules and associated specialized hardware of service provider server 120 to provide an automated agent 132 that may include one or more applications, conversational AI, and components that may be used with compliance investigations performed by service provider server 120. In this regard, compliance investigation platform 130 may correspond to specialized hardware and/or software used by an internal agent, compliance officer, investigator, or other user associated with client device 110 to perform compliance investigations. For example, compliance investigation platform 130 may receive request 114 from client device 110 and process request 114 using automated agent 132 provided for a compliance investigation framework of service provider server 120. Based on request 114, compliance investigation platform 130 may provide a conversational AI and other chatbot feature and processes to respond to prompts, requests, questions, queries, or other statements provided during the course of a compliance investigation. In this regard, automated agent 132 includes LLMs 134 for providing compliance investigation processing and task execution, including via prompts to intelligent LLMs, GPTs, or other AIs, as well as a toolkit 136 used for task execution and a data guard 138 to protect privacy protected, secure, and/or sensitive data and ensure compliance adherence and enforcement during investigations.

As such, compliance investigation platform 130 may provide automated agent 132 through one or more interfaces, include chat sessions and/or communication channels where a user may engage in communicating with LLMs 134 to perform compliance investigations. As such, data scientists and other model training teams may train LLMs for automated agent 132, including one or more LLMs, AI or ML models, NNs, conversational AIs, or the like. LLMs 134 may have trained layers based on training data and selected features or variables configured to generate conversation or dialogue for compliance investigations, as well as generate and process tasks to respond to requests associated with compliance investigations. For example, ML features or variables may correspond to individual pieces, properties, characteristics, or other inputs for an ML model and may be used to cause an output by that ML model once the ML model has been trained using data for those features from training data. LLMs 134 may be used for computation and calculation of model scores based on layers, nodes, branches, clusters, rules, and the like that are trained and optimized. As such, ML models may be trained to provide a predictive output, such as a score, likelihood, probability, or decision, associated with a particular prediction, classification, or categorization.

For example, LLMs 134 may include deep neural networks (DNNs), MLS, generative AIs, or other AI models trained using training data having data records that have columns or other data representations and stored data values (e.g., in rows for the data tables having feature columns) for the features. When building LLMs 134, training data may be used to generate one or more classifiers and provide recommendations, predictions, or other outputs based on those classifications and an ML or NN model algorithm and architecture. For example, with LLMs, training data may correspond to different corpora of documents and information, which may then allow the models to respond intelligently based on learning for such corpora. The algorithm and architecture for the LLMs 134 may correspond to DNNs, ML decision trees and/or clustering, conversational AIs, LLMs, generative AI, and other types of AI, ML, and/or NN architectures. The training data may be used to determine features, such as through feature extraction and feature selection using the input training data.

For example, DNN models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for ML models that attempt to classify and/or categorize the input feature data and/or data records. Thus, when the LLMs 134 are used to perform a predictive analysis and output, the input data may provide a corresponding output based on the trained classifications.

Layers, branches, clusters, or the like of the LLMs 134 may be trained by using training data associated with data records of interest, such as information associated with compliance investigations. This may include compliance laws, rules, regulations, and/or guidelines for an organization (e.g., one associated with service provider server 120) and/or based on the service provided and/or data managed by the organization. In this regard, for training LLMs 134, corpora of documents associated with compliance investigations, such as past investigations, results, and the like, may be used. With fraud investigations, this may include fraud reports, SARs, fraud investigations and resolutions, and the like. By providing training data, the nodes in the hidden layer may be trained (adjusted) such that an optimal output (e.g., a classification) is produced in the output layer based on the training data. By continuously providing different sets of training data and/or penalizing the LLMs 134 when the outputs are incorrect, the LLMs 134 (and specifically, the representations of the nodes in the hidden layer) may be trained (adjusted) to improve its performance in data classifications and predictions. Adjusting of the LLMs 134 may include adjusting the weights associated with each node in the hidden layer.

Automated agent 132 may utilize LLMs to output responses to compliance investigation requests, queries, questions, prompts, and the like. As such, LLMs 134 may include a generalized main-LLM-worker, which may organize, determine, and execute overall tasks for compliance investigations. Automated agent 132 may further invoke specialized-LLM-workers, which may perform specific execution of sub-tasks for certain specialized knowledge domains, requirements, and task executions. To execute tasks, such as to query and search databases, request data, transform data between platforms and/or components, and perform other functionalities, toolkit 136 may be invoked by automated agent 132 during the course of use of LLMs 134. In this regard, toolkit 136 may correspond to a wrapper of an existing functionality of service provider server 120, such as those associated with service applications 122 and/or database 124. As such, different artifacts may be wrapped as tools for toolkit 136, including functions in libraries, Representational State Transfer (REST) APIS and endpoints, and other internal and external tools including other users that may be used for manual intervention when needed. Data guard 138 may further be used in the course of compliance investigations, processing tasks, and responding to request 114 and other data from users, which may generate insights without revealing underlying data, mask data, and the like. As such, data guard 138 may protect from sharing information with public LLMs, including during the course of training and configuring LLMs.

Service applications 122 may correspond to one or more processes to execute modules and associated specialized hardware of service provider server 120 to process a transaction and/or provide other computing services to users. For example, service applications 122 may be used to process payments and other services to one or more users, merchants, and/or other entities for transactions, where compliance investigation platform 130 may be used for compliance requirements of those services, applications, websites, data, and the like. In this regard, the account may be used to send and receive payments, including those payments that may be enabled through a website and/or application of users, merchants, and other transaction participants. A payment account may be accessed and/or used through a browser application and/or dedicated payment application executed by a device, such a payment and/or digital wallet application. Service applications 122 may process payments and may provide transaction histories to client device 110 and/or another user's device or account for transaction authorization, approval, or denial of the transaction for placement and/or release of the funds, including transfer of the funds between accounts based on compliance investigations.

Further, service applications 122 may provide different computing services, including social networking, microblogging, media sharing, messaging, business and consumer platforms, etc. These computing services may be used by customers and users, and therefore compliance investigation platform 130 may be used for other computing services. Service applications 122 as may provide additional features to service provider server 120. For example, service applications 122 may include security applications for implementing server-side security features, programmatic client applications for interfacing with appropriate APIs over network 140, or other types of applications. Service applications 122 may contain software programs, executable by a processor, including one or more GUIs and the like, configured to provide an interface to the user when accessing service provider server 120, where the user or other users may interact with the GUI to view and communicate information more easily. Service applications 122 may include additional connection and/or communication applications, which may be utilized to communicate information to over network 140.

Additionally, service provider server 120 includes or may access database 124. Database 124 may store various identifiers associated with client device 110. Database 124 may also store account data, including payment instruments, financial information, account balances, and authentication credentials, as well as transaction processing histories and data for processed transactions. Database 124 may include information used during compliance investigations, including SARs, fraud reports, transaction histories, and other available data that may assist in processing tasks to investigate compliance issues. Although database 124 is shown as residing on service provider server 120 as a database, in other embodiments, other types of data storage and components may be used including cloud computing storage nodes, remote data stores and database systems, distributed database systems over network 140 and/or of a computing system associated with service provider server 120, and the like.

Service provider server 120 may include at least one network interface component 128 adapted to communicate client device 110 and/or other devices and servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

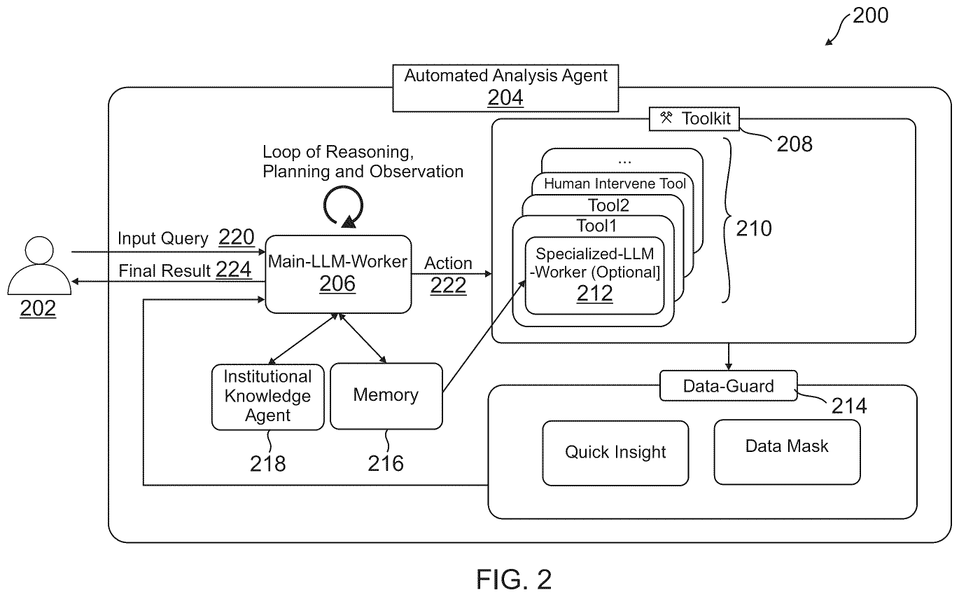

FIG. 2 is an exemplary system environment 200 where an intelligent and automated agent may be provided through a framework that provides compliance investigations through large language models and other components, according to an embodiment. System environment 200 may include components of service provider server 120 that may be utilized by client device 110 for compliance investigations facilitated using an automated agent with LLMs, as discussed in reference to system 100 of FIG. 1. In this regard, system environment 200 may correspond to a computing system for compliance investigation platform 130, where a user 202 may interact with the computing system via client device 110 to request processing of different queries, questions, statements, and the like for a compliance investigation.

In system environment 200 of FIG. 2, an embodiment of compliance investigation platform 130 may provide an automated analysis agent 204 to user 202. Automated analysis agent 204 may correspond to the intelligent automation that may provide a conversational AI utilizing one or more LLMs to converse with user 202 during the course of processing queries and other requests for a compliance investigation. Initially, user 202 may interact with main-LLM-worker 206 of automated analysis agent 204 for compliance investigation query submission and request processing. Main-LLM-worker 206 may identify the role of automated analysis agent 204 in processing the query and/or performing the compliance investigation. As such, main-LLM-worker 206 may determine and understand tasks for processing the query for the compliance investigation, be familiar with and identify available tools for use, and leverage the reasoning and planning capacity of different LLMs to complete the task. Main-LLM-worker 206 may operate iteratively with each round of the compliance investigation's tasks or requests as an individual prompt to the LLM, which may employ a selection process to determine the appropriate tool from a toolkit 208 of internal resources. Once chosen, the selected tool executes the task, providing feedback to main-LLM-worker 206 based on observations and other outputs. Subsequently, main-LLM-worker 206 utilizes this feedback to plan subsequent iterations for additional tasks and/or query processing, as well as produce a report or other result of the compliance investigation.

Toolkit 208 may correspond to a collection, aggregation, library, or other resource indicating tools 210 available to automated analysis agent 204 for conducting compliance investigations. A tool may correspond to a wrapper of an existing functionality of the service provider and/or computing system that may provide and/or process compliance investigations. As such, each of tools 210 may have a defined name, input parameters, and description. For example, a wide range of artifacts may be wrapped as tools, such as functions in libraries, REST APIs, AI models, microservices, and the like. Tools 210 may include a human intervention tool that may be used to ensure that main-LLM-worker 206 is performing correctly and adequately behaving or responding to the task at hand. As such, the human intervention tool may provide an application or process to request a human intervene and/or provide intervention in specific circumstances. For example, the human intervention tool may correspond to a special tool that, when information provided in a prompt to an LLM is insufficient to generate the proper result, more input with specific information from a human may be requested and/or appended to the next round prompt for assistance with result generation.

Toolkit 208 may include various internal tools, each assigned to solve specific tasks. Additionally, certain tasks may require capabilities of an LLM. Specialized-LLM-worker 212, which can be optional depending on various factors, such as the query, the compliance, desired accuracy, and cost, may utilize a collaborative memory sharing mechanism or technique with main-LLM-worker 206 to function as a dual-LLM-worker mechanism, which allows for robust performance across diverse tasks that may require main, primary, or overall task performance and orchestration by main-LLM-worker 206 with execution and performance of sub-tasks by specialized-LLM-worker 212 for those sub-tasks requiring domain-specific and/or specialized knowledge, resources, and/or training.

For example, with LLMs, breakdowns in reasoning and intelligent understanding of prompts and tasks may occur when tasks are very complicated, have long inputs or outputs, or otherwise span many domains, as the knowledge basis becomes large or unwieldy to utilize for intelligently responses. As such, to optimize the efficiency of main-LLM-worker 206, specialized-LLM-worker 212 may be used that is dedicated to specific tasks that may be sub-tasks in the overall execution of the task by main-LLM-worker 206. Specialized-LLM-worker 212 may be required to have knowledge of the overall target and the historical sub-tasks, which may be granted through the collaborative memory that is shared between the LLMs. While doing so, the memory of specialized-LLM-worker 212 may not impact the memory of main-LLM-worker 206 as the memory does not have relevance to other tasks. This may optimize the performance of both LLMs. Further, toolkit 208 may support easy integration of additional tools as needed.

A data guard 214 may be utilized to address the challenge of data security in LLM-related applications. Data guard 214 may incorporate a configurable data security processor module, which may generate insights from data without revealing the data or mask sensitive data as required. This may ensure the protection of proprietary, secure, and/or sensitive (e.g., privacy protected) information that cannot or should not be shared with public LLMs. With quick insights generated by data guard 214, valuable insights may be extracted from diverse raw data sources, including text, business metrics, and transaction or linking knowledge graphs. This may utilize algorithms designed to unveil meaningful patterns and information. For example, when evaluating key business metrics of an account, including total payment volume (TPV), balances, and the like, such data may be input to an LLM, which may be a significant risk of exposing confidential customer data to public LLMs that may share and/or utilize the data during further decision-making. This may similarly occur with payment memos and notes provided with payments and other transactions, which may include security numbers, a further risk overwhelming the LLM with an excessive volume of data. As such, data guard 214 may be utilized to generate insights that minimize information gaps without the need for explicit prompts. This may be done by processing inputs and results to identify any use of specific identifiers, identification information, and other personally identifiable information (PII) that may be used. Further, rules may be set for data to be cleansed, masked, and/or transformed prior to processing and/or output. As such, PII may not be prompted to an LLM directly, and any data leakages or return of PII may be prevented.

Main-LLM-worker 206 may further interact with a memory 216, which may include the collaborative memory shared between the different LLMs of automated analysis agent 204. Memory 216 may retain a comprehensive record of past iterations, actions, LLM thoughts or outputs, and/or observations. The historical data may aid with iterative reasoning and may also be accessed by specialized-LLM-worker 212 to operate in a more comprehensive and global manner. Memory 216 may therefore allow the collaborative memory sharing for LLM use. An institutional knowledge agent 218 may be used to append pertinent information from knowledge sources to the overall prompt to the LLM. This may improve specific problem-solving capabilities to align with internal requirements, concepts, and processes that may be different from public knowledge used to train the LLM. For example, institutional knowledge agent 218 may include data from acceptable use policies (AUPs), regulation policy documents, and/or other guideline documents for company or organizational compliance. Other data may include case review historical documents for past compliance investigations and steps/tasks taken,

To append data, institutional knowledge agent 218 may perform indexing on the incoming query or prompt to the LLM, which may translate the raw material to a form suitable for relevance query, such as embeddings or a keyword index and store the indexing data. A storage may be queried with the input question or a transformation of the question to obtain the most relevant contents from storage that is associated with the internal knowledge. An optional reranking step may be performed when multiple sources and heterogeneous indexing/query technologies may be used in a single run. Thereafter, the prompt may be generated by appending the returned knowledge to the prompt.

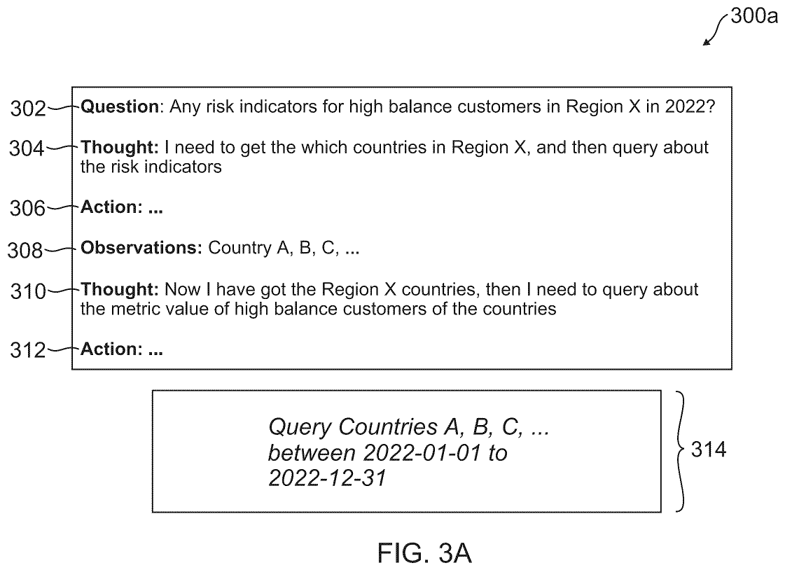

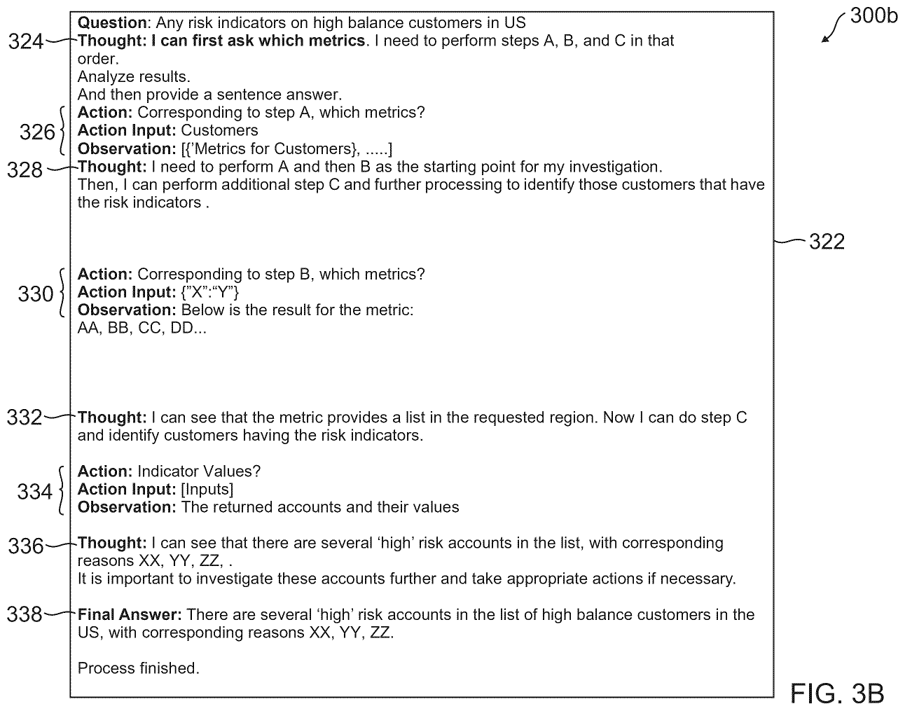

As such, an input query 220 may be processed using the components of automated analysis agent 204. This may include performing a loop of reasoning, planning, and observation by main-LLM-worker 206 so that an action 222 may be determined. When planning and generating action 222 based on input query 220, memory 216 of past iterations and institutional knowledge agent 218 may first be invoked to perform further refinement and appending of information for proper prompting of main-LLM-worker 206 and/or specialized-LLM-worker 212. Action 222 may then be processed using toolkit 208 with data guard 214, where action 222 may correspond to a plan having one or more tasks for execution (e.g., an overall task for processing input query 220 and responding). Based on the output from processing action 222, a final result 224 may be returned to user 202, which may be provided back as a response from the LLM in a conversational dialog for the conversational AI. Final result 224 may also be used to update a corresponding compliance investigation, such as using the outputs shown in FIGS. 3A and 3B below.

FIGS. 3A and 3B are exemplary diagrams 300a and 300b of prompts and responses from large language models that may be implemented with an automated agent for a compliance investigation framework, according to various embodiments. Diagrams 300a and 300b include conversational dialog, chats, or the like that may be presented to a user on a user device, such as application 112 on client device 110 in system 100 of FIG. 1, based on engagement with automated agent 132 provided by compliance investigation platform 130 of service provider server 120. As such, diagrams 300a and 300b may include responses to prompts for a compliance investigation provided by conversational AI bot, engine, LLMs, and the like.

Referring now to diagram 300a of FIG. 3A, initially a question 302 may be prompted to an automated agent that utilizes one or more LLMs for prompt processing and response. In the chat shown in diagram 300a, a dialog having question 302 queries whether there are risk indicators for high balance customers in a region during a year. To respond to question 302, the automated agent may then provide, based on processing the prompt using an LLM, a thought 304 on how to process question 302 and execute an action 306, which may correspond to a task that may be executable using various available tools. An observation 308 may be provided to indicate a list of countries within the region, which may correspond to execution of a sub-task during overall task execution. In response to observation 308, the LLM of the automated agent may provide a new thought 310, which indicates a list of countries for the region and allows for a more specific search of the high balance customer risk indicators. A further action 312 may be executed, which may correspond to a database query 314 constructed by the LLM. Database query 314 may then be used to query a database or one or more other data sources for a response to question 302.

Referring now to FIG. 3B, in diagram 300b, a question 322 requiring performance of multiple actions for different sub-tasks required by the planning of an overall task is shown. In response to question 322 to an automated agent, an LLM of the automated agent may perform initial planning and task orchestration such that a first thought 324 is generated to first determine the correct metrics by which to analyze for investigation purposes of the compliance investigation request, query, or the like in the prompt of question 322. A first action 326 may be returned by the LLM based on the toolkit and tools available for use, as well as any shared memory, institutional knowledge, and use of a data guard. First action 326 may identify the metrics that may be used for analysis of question 322, which may correspond to a set of query parameters or query values to obtain the corresponding metrics from a database for analysis.

After determination of first action 326, a second thought 328 may then be determined for the particular set of “customers” or other data from which to analyze the previously determined metrics. A second action 330 may be executed to determine and obtain the particular data set of interest for question 322. This may be done based on query parameters to obtain a data set matching the customers of interest, such as high balance customers. A third thought 332 may then be determined for resolving question 322 by identifying the corresponding indicators or other requested result based on the metrics and customers (e.g., the corresponding retrieved data sets based on the determined query parameters or values). As such, a third action 334 may be executed to obtain a subset of the data resulting from first action 326 and second action 330. A final though 336 may provide a condensed result of execution of first action 326, second action 330, and third action 334. Final thought 336 may be used to provide a final answer 338 in response to question 322, which may be added to or updated with a corresponding compliance investigation.

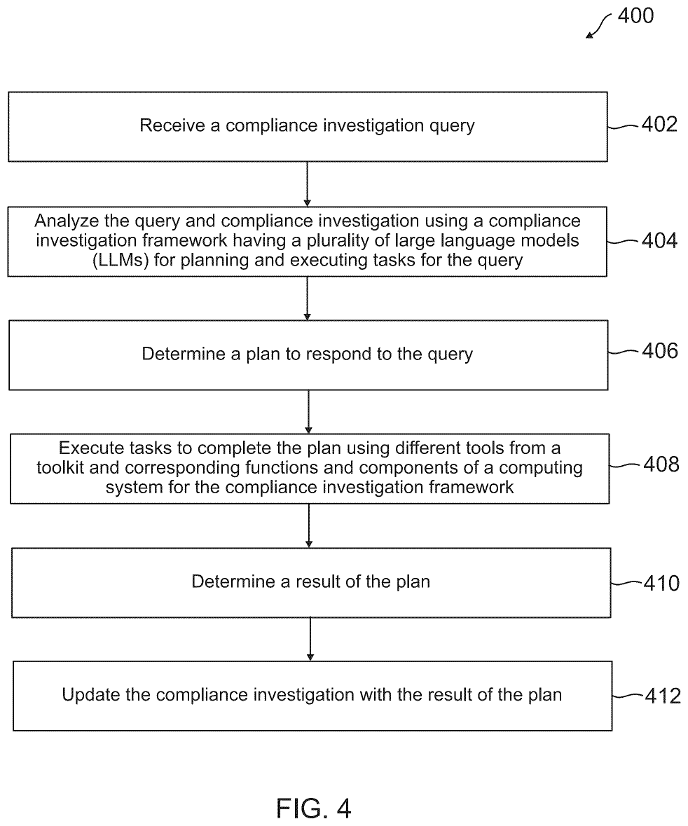

FIG. 4 is a flowchart 400 of an exemplary process for a domain-knowledge guided agent framework for automated system analysis, according to an embodiment. Note that one or more steps, processes, and methods described herein of flowchart 400 may be omitted, performed in a different sequence, or combined as desired or appropriate.

At step 402 of flowchart 400, a compliance investigation query is received. For example, automated agent 132 provided by compliance investigation platform 130 of service provider server 120 may receive request 114 from client device 110. The query may correspond to a requested action or task to be performed to investigate compliance issues, fraud or other activity that may violate compliance rules, regulations, and laws, and the like. As such, the query for a compliance investigation may be transmitted by a user, such as an investigator, to an automated agent of a compliance investigation framework. The automated agent may correspond to a computing bot or other automated application and/or operations to respond to the query and may utilize LLMs for query processing and response. As such, in some embodiments, the query may be received as and/or structured as a prompt to an LLM, which may include crafted queries and/or instructions that elicit outputs from the LLMs for compliance investigations, such as a question or statement that may include instructions for the LLM to execute, restrictions or parameters of how to execute those instructions, as well as any additional data, context, and/or data sources for the LLM to use when responding to the question/statement.

At step 404, the query and compliance investigation are analyzed using a compliance investigation framework having a plurality of large language models (LLMs) for planning and executing tasks for the query. In this regard, compliance investigation platform 130 may correspond to a framework that executes automated agent 132 having LLMs 134. A main-LLM-worker of LLMs 134 may analyze the query initially using knowledge and documents associated with compliance investigations to break down the query into actionable tasks. As such, at step 406, a plan to respond to the query is determined. The plan may correspond to one or more overall tasks, as well as any sub-tasks to be completed in order to successfully complete the overall task(s). The task(s) may be determined, and the tools needed to complete the tasks may be determined. The plan may include individual steps for tasks to complete that allow the automated agent to respond to the query for the compliance investigation.

At step 408, tasks to complete the plan are evaluated using different tools from a toolkit and corresponding functions and components of a computing system for the compliance investigation framework. When evaluating the tasks, LLMs 134 may be utilized including a main-LLM-worker that may perform overall task execution and organization with specialized-LLM-workers for execution of any sub-tasks requiring particular knowledge, such as knowledge of a corresponding domain, field, service, data set, or the like. Thus, LLMs 134 may include LLMs trained on these certain domains.

To execute tasks by LLMs 134, toolkit 136 may be invoked to determine and utilize the functionalities and capabilities of the service provider and framework, such as those operations that may be available to compliance investigation platform 130 to execute. Data guard 138 may also be utilized to prevent revealing or utilizing secure, sensitive, or otherwise privacy protected data when processing the tasks and generating responses. For example, to prevent LLMs 134 from utilizing the privacy protected data for users, including retaining, retraining, and/or reinforcement or continuous learning, data may be masked by data guard 138 prior to being providing to LLMs 134 and/or output by LLMs 134 during compliance investigations. This may ensure further adherence to compliance requirements.

At step 410, a result of the plan is determined. The result may be determined based on an output of the overall tasks by LLMs 134 and may include any executable actions to take for compliance investigations and their corresponding outputs as determined by LLMs 134. For example, specific search results, fraud investigation determinations, and the like may be determined as a result of executing one or more overall tasks, which may include any sub-tasks executed during the course of overall task execution. At step 412, the compliance investigation is updated with the result of the plan. Request 114 may be updated and/or responded to with an output from automated agent 132 to provide a response and/or determination made from the compliance investigation. As such, the compliance investigation may be updated to have information that may assist with resolution of the issue and/or actions to take to ensure compliance requirements are adhered to and enforced.

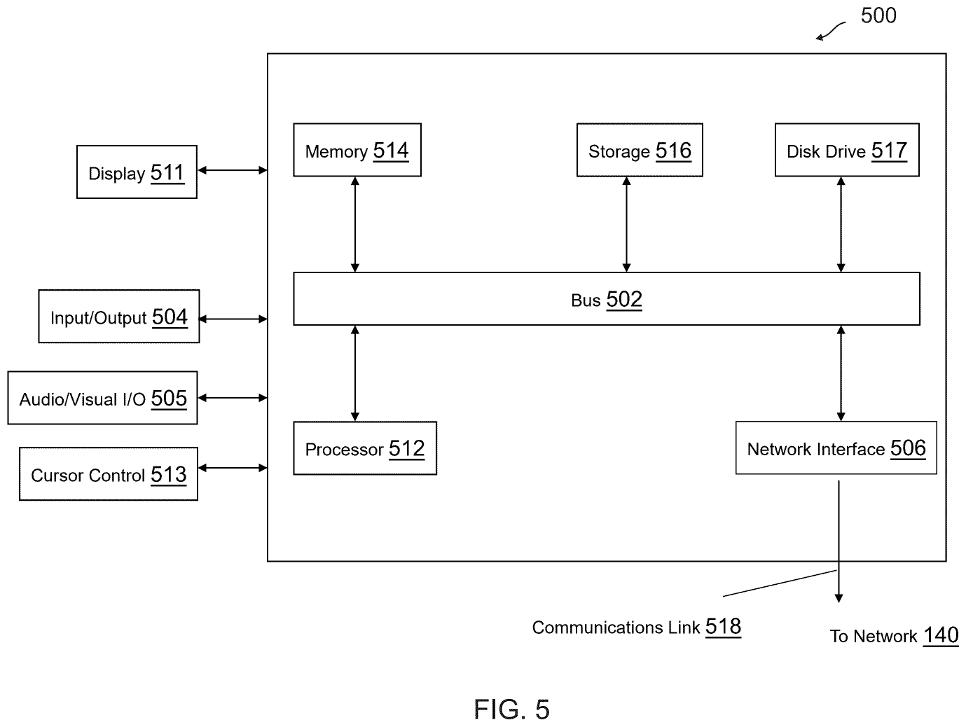

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output component 505 may also be included to allow a user to use voice for inputting information by converting audio signals and/or use video to capture still or video images and provide video input. Audio I/O component 505 may allow the user to hear audio and/or view video. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method comprising:
receiving a request for an investigation;
analyzing the request using a first large language model (LLM) module of an investigation framework comprising a toolkit comprising a plurality of wrapper functions for different investigation tools and historical data records for past investigations;
determining, using the first LLM module, an executable plan comprising a first task for the investigation;
identifying an investigation tool for the first task from the toolkit;
executing the first task using a corresponding one of the plurality of wrapper functions for the investigation tool;
determining a result of the executing the first task; and
updating the executable plan based on the result.

2. The method of claim 1, wherein the first task includes a sub-task that uses a second LLM module to complete, wherein the second LLM modules is trained on domain-specific knowledge for a domain associated with the sub-task and different investigations of the service provider, and wherein the executing the first task further uses the second LLM module, wherein the second LLM module plans and performs the sub-task using at least the domain-specific knowledge and available data for the domain.

3. The method of claim 2, wherein the first LLM module and the second LLM module comprise a dual LLM-worker mechanism using a collaborative memory shared between the first LLM module and the second LLM module, and wherein the first LLM module is assigned overall tasks performed by the investigation framework and the second LLM module is assigned sub-tasks for the overall tasks by the first LLM module.

4. The method of claim 1, wherein the executable plan comprises a plurality of tasks including the first task, and wherein the method further comprises:
orchestrating, by the first LLM module, each of the tasks of the plurality of tasks for completions of the tasks using the toolkit;
evaluating results of each of the tasks; and
outputting an investigation result of the executable plan for the investigation based on the results of each of the tasks.

5. The method of claim 1, wherein the request is received by an automated agent of the investigation framework, and wherein the automated agent comprises a centralized hub of the investigation framework that connects the first LLM module, the toolkit, and at least one additional component of the investigation framework that aggregates and synthesizes information from compliance policies responsive to the investigation.

6. The method of claim 1, wherein the request to the first LLM module comprises a prompt structured for the first LLM module and having instructions for the investigation, investigation data for the investigation, and a desired result of processing the instructions based on the investigation data and knowledge of the first LLM module.

7. The method of claim 1, wherein the different investigation tools of the toolkit include at least one of:
a data collection tool that determines and collects investigation data or compliance policy data from one or more data sources;
a user intervention tool that requests user input for the investigation; or
a reporting tool that generates structured reports for the investigation.

8. The method of claim 1, wherein the executable plan further comprises a second task, and wherein the method further comprises:
orchestrating the first task with the second task for the executable plan, wherein the orchestrating utilizes a data privacy module that guards data used for the first task and the second task based on a data privacy requirement.

9. A system comprising:
a non-transitory memory; and
one or more hardware processors coupled to the non-transitory memory and configured to execute instructions to cause the system to:
receive a request to perform a compliance investigation, wherein the request comprises instructions, investigation data, and a desired result of the compliance investigation;
analyze the request using a first large language model (LLM) module and historical data records for past compliance investigations;
determine a task for the compliance investigation based on analyzing the request, wherein the task includes a sub-task for a performance by a second LLM module having specialized knowledge corresponding to a domain associated with the compliance investigation;
select a compliance investigation tool for the task from a toolkit comprising a plurality of wrapper functions for different compliance investigation tools;
execute the task using the second LLM module for the sub-task and a corresponding one of the plurality of wrapper functions for the compliance investigation tool; and
update the compliance investigation based on executing the task.

10. The system of claim 9, wherein executing the instructions further cause the system to:
select the second LLM module for the sub-task based on training of the second LLM module for domain knowledge of a specific domain.

11. The system of claim 9, wherein the first LLM module and the second LLM module comprise a dual LLM-worker mechanism using a collaborative memory shared between the first LLM module and the second LLM module.

12. The system of claim 9, wherein the first LLM module is assigned the task by an automated agent of the investigation framework and the second LLM module is assigned the sub-task for the task by the first LLM module.

13. The system of claim 9, wherein executing the task includes prompting at least the first LLM module based on at least one of the instructions, the investigation data, the desired result, the task, or the compliance investigation tool.

14. The system of claim 9, wherein the compliance investigation comprises a fraud investigation of a detected fraudulent event with an online transaction processor.

15. The system of claim 9, wherein the toolkit comprises at least one of a data collection tool for data from one or more data sources, a user intervention tool for user input, or a reporting tool for report generation.

16. The system of claim 9, wherein executing the instructions further cause the system to:
orchestrate the task and the sub-task between the first LLM module and the second LLM module.

17. A non-transitory machine-readable medium having stored thereon machine-readable instructions executable to cause a machine to perform operations comprising:
receiving a prompt associated with an investigation, wherein the prompt includes instructions, investigation data, and a desired result of the investigation;
generating, using a first large language model (LLM) module of an investigation framework of a service provider, an executable plan comprising a task for the investigation based on an analysis of the prompt and historical data records for past investigations, wherein a performance of a sub-task of the task is able to be executed by a second LLM module;
determining a tool for the task from a toolkit comprising a plurality of wrapper functions for different tools;
executing the task using the second LLM module for the sub-task and a corresponding one of the plurality of wrapper functions for the tool; and
providing a result of the executed task to the prompt.

18. The non-transitory machine-readable medium of claim 17, wherein the first LLM module and the second LLM module comprise a dual LLM-worker mechanism using a collaborative memory shared between the first LLM module and the second LLM module.

19. The non-transitory machine-readable medium of claim 17, wherein the first LLM module is assigned the task by an automated agent of the investigation framework and the second LLM module is assigned the sub-task for the task by the first LLM module.

20. The non-transitory machine-readable medium of claim 17, wherein the executing the task includes securing, using a data guard module, privacy protected data from being revealed to the first LLM module or the second LLM module when executing the task.
